(19) United States
(12) Patent Application Publication
(10) Pub. No.: US 2023/0150723 A1
(43) Pub. Date: May 18, 2023

(54) A SEALED PACKAGE FOR STACKABLE CANDLES

(71) Applicant: AROMAT FRAGRANCES INDUSTRIES LTD, Petah Tikva (IL)

(72) Inventor: Joseph BASSA, Petah Tikva (IL)

(21) Appl. No.: 17/916,588

(22) PCT Filed: Apr. 6, 2021
(86) PCT No.: PCT/IL2021/050387

§ 371 Date: Oct. 3, 2022

(30) Foreign Application Priority Data
Apr. 7, 2020 (IL) 273866

(51) Int. Cl. B65D 17/28; B65D 21/02; C11C 5/00; F21V 35/00

(52) U.S. Cl. CPC B65D 17/4011; B65D 21/0217; C11C 5/006; F21V 35/00; B65D 2517/0056; B65D 2517/0014

(57) ABSTRACT

A packaging system for candles, comprising an enclosure which consists a candle with one or more wicks; a cover to which an opening handle is connected, for opening the enclosure before use; a rigid lighting surface connected to the inner surface of the enclosure's cover, for lighting the candle by friction; matches for lighting the candle by rubbing with the rigid lighting surface; a sticker or slots for affixing the matches to the inner surface of the enclosure's cover, near the lighting surface.

### FIELD OF THE INVENTION

The present invention relates to the field of candle packages. More particularly, the present invention relates to a sealed package for stackable candles.

### BACKGROUND OF THE INVENTION

Nowadays, candles are a product often used for religious ceremonies, such as soul candles or memorial candles that remain lit for a long time (long-lit candles). Such candles are usually stored in a glass or metal enclosures. The disadvantage of a glass enclosure is that it is fragile and not sealed. The conventional available metal enclosures for candles are open metal cans without covers, in which the candle is unprotected. In these open metal cans the wick and wax can be damaged by contact with objects or when stored.

In addition, the open enclosure structure is unstable and can slip and therefore, the candles in this enclosure cannot be stacked on top of one another. This requires a lot of space in their storage and wastes resources and storing space. The open enclosure structure also enables the entering of moisture and wetness, which can damage the candle and the wick.

There are also conventional solutions with a sealed cap, such as a candle packed in a hermetically sealed metallic enclosure with a sunken lid. Inside the candle enclosure there is a flat match box ed for lighting the candle, which is placed on the candle wick(s) and is free to move. However, this type of flat match box has several drawbacks:
The flat match box is free to move and can harm the candle, and especially the wick(s).
For lighting the candle, there is a need to rub the match on a thin, soft phosphorous surface, typically made of cardboard. In case when the user fails to light the match after one attempt or two, no phosphorus remains, since it rubs and peels off and the user cannot light the candle with the remaining matches.
Since the matches case is external, it is a relatively expensive case that contains a large number of matches and must be purchased from an external supplier. This case is relatively large, takes up a lot space inside the candle enclosure, weighs relatively a lot and wears away relatively quickly.

It is therefore an object of the present invention to provide a sealed cheap and efficient enclosure for stackable candles, with a reliable lightning option and a high chance of lightning in the first attempting.

Other objects and advantages of the invention will become apparent as the description proceeds.

### SUMMARY OF THE INVENTION

A packaging system for candles, comprising:
a) an enclosure which consists a candle with one or more wicks;
b) a cover to which an opening handle is connected, for opening the enclosure before use;
c) a rigid lighting surface connected to the inner surface of the enclosure's cover, for lighting the candle by friction;
d) matches for lighting the candle by rubbing with the rigid lighting surface; and
e) a sticker or slots for affixing the matches to the inner surface of the enclosure's cover, near the lighting surface.

The enclosure and/or the cover may be made of metal, and may have a shape of a can, such that the package is sealed.

The enclosure and/or the cover may be made of a polymeric material such as plastic, and having a shape of a can.

In one aspect, the opening mechanism of the candle's enclosure may be similar to the opening mechanism of a can or tin can.

The cover may be sunken, for enabling putting packages in a stack one on top of each other, for storing and transporting them.

The rigid lighting surface may be a phosphorus surface, similar to the lighting surface of a matchbox. The matches may be affixed by a sticker on the inner side of the cover surface near the phosphorus surface.

The matches may lie scattered on the candle, in the space between the candle in the enclosure and its cover or may be inserted into slots, formed in the enclosure cover, instead of using a sticker.

The enclosure's cover may be used as a windshield when it is in about 90° open position, which prevents the wind from extinguishing the candle flame and facilitates lighting the candle.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates the proposed enclosure for stackable candles, in a closed position, according to an embodiment of the present invention;

FIG. 2 illustrates the proposed enclosure for stackable candles, in an open position with the cover removed, according to an embodiment of the present invention;

FIG. 3A-3B illustrate the proposed enclosure for stackable candles, in an open position with the cover partially removed (stands in 90° position) according to an embodiment of the present invention; and

FIG. 4 illustrates the proposed enclosure for stackable candles, in an open position with the cover partially removed (stands in 90° position) according to another embodiment of the present invention.

### DETAILED DESCRIPTION OF THE PRESENT INVENTION

The present invention provides a sealed cheap and efficient enclosure for stackable candles, with a reliable light option with a high chance of light on the first attempting.

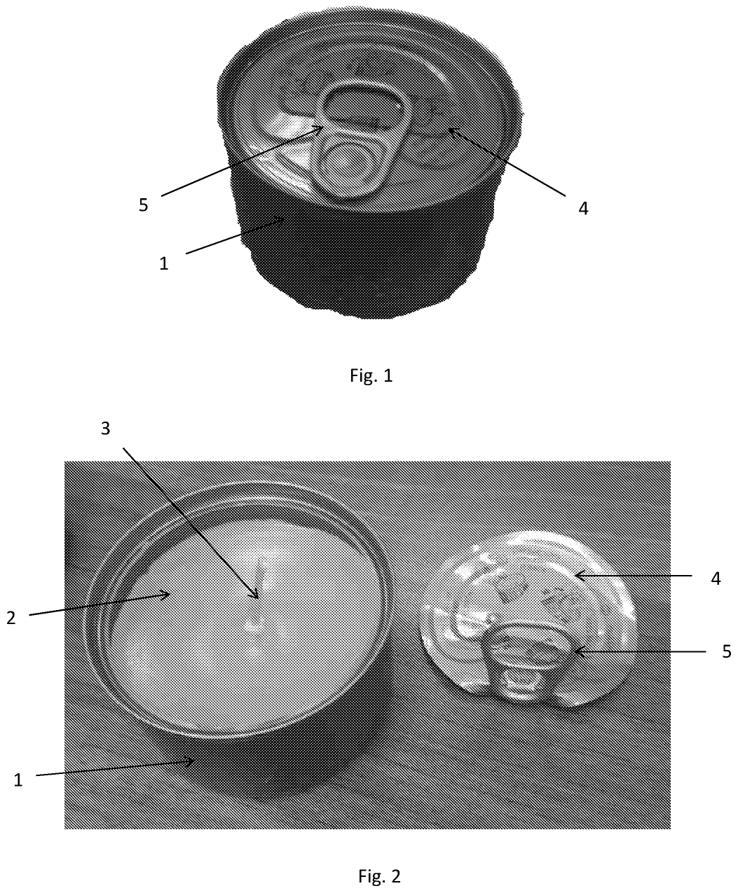

FIG. 1 illustrates the proposed enclosure for stackable candles, in closed position, according to an embodiment of the present invention. The enclosure 1 consists a candle 2 with a wick(s) 3. To the outer side of the enclosure's cover 4 is connected an opening handle 5, which enables to open the enclosure 1 like the opening mechanism of a can/tin can. The cover 4 is sunken, for enabling putting candles in a stack one on top of each other (the bottom of one candle is entering to the sunken space above the cover 4 of the candle 2 which positioned in the stack under the first candle), for allowing easy transport and storage the candles, while saving storage space. Cover 4 and enclosure 1 may be metallic or may be made from a polymeric material, such as plastic.

FIG. 2 illustrates the proposed enclosure for stackable candles, in an open position with the cover 4 removed, according to an embodiment of the present invention.

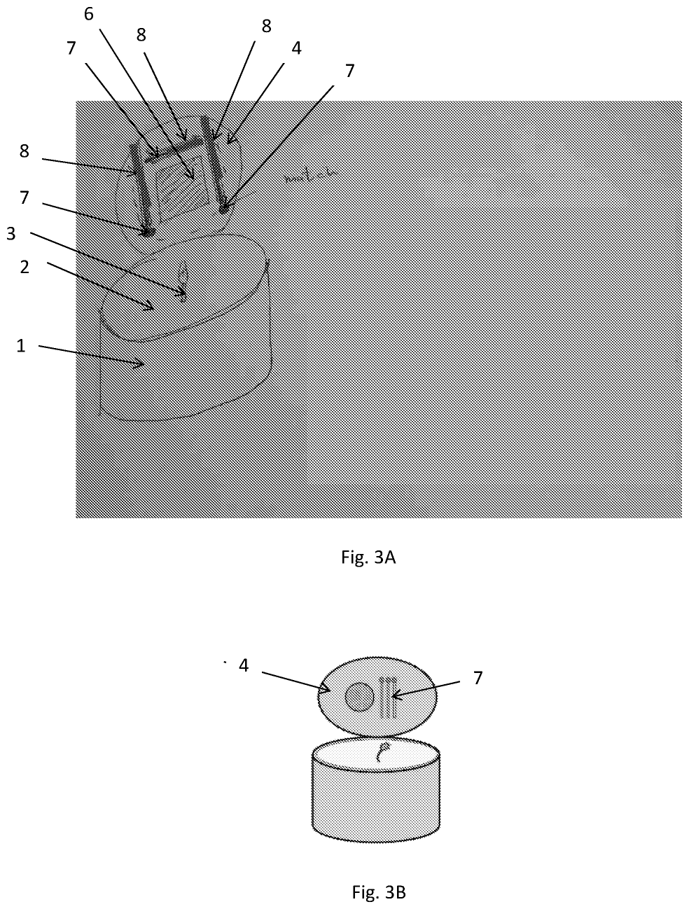

FIG. 3A illustrates the proposed enclosure for stackable candles, being in an open position with the cover 4 half removed (stands in 90° position), according to an embodiment of the present invention. To the inner side of the enclosure's cover 4 is connected (through paste, by a sticker or by direct connection) a rigid phosphorus surface 6, like in a matchbox, for allowing lighting the candle 2 with a matches 7 when needed. In one option, the matches 7 are affixed by a sticker 8 on the inner side of the cover 4 surface near the phosphorus surface 6. The advantage of this option is that the matches 7 do not rustle and do not cause harm to the wick(s) 3 of the candle. In another option, the matches 7 lie scattered on the candle, in the space between the candle 2 in the enclosure 1 and its cover 4. The user can take a match 7 and light the candle 2 by rubbing this match 7 on the phosphorous lighting surface 6.

FIG. 3B illustrates the proposed enclosure for stackable candles in an open position, where three matches 7 are affixed by a sticker to the inner side of the cover 4.

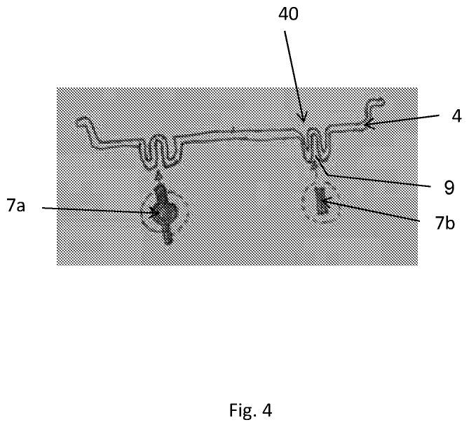

FIG. 4 illustrates a bended cover for holding the matches in place, according to another embodiment of the present invention. In this embodiment, the cover is made with tortuous bending 40, to form slots 9, which are slightly narrower than the thickness of a match. Then, the matches 7a (front view) and 7b (rear view) are inserted into small slots 9 in the enclosure cover 4, instead of using a sticker.

### The Advantages of the Present Invention

The enclosure's cover can be used as a windshield when it is in about 90° in its open position, which prevents the wind from extinguishing the candle flame and facilitates lighting the candle. If the user doesn't need a windshield, the cover can be entirely removed.
Thanks to the enclosure's cover sealed and hermetically sealed structure, the matches inside it are protected and not exposed to moisture and wetness, which can harm them.
The rigid, non-bending phosphorous lighting surface provides contrast while opening the opening of the candle's cover, and thus facilitates the opening more easily.
Matches without a chassis (a case) are cheaper than an external case which consists large amount of matches (about 10 matches), which should be purchased from an external supplier and can cause harm to the wick(s) of the candle.
The amount of trash that remains after using the matches is much less compared to a match box. Therefore, the proposed packaging system for candles is also environmental friendly.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

1. A packaging system for candles, comprising:
a) an enclosure which consists a candle with one or more wicks;
b) a cover, to which an opening handle is connected, enabling to open said enclosure;
c) a rigid lighting surface connected to the inner surface of said enclosure's cover, for allowing lighting said candle;
d) one or more matches for lighting said candle by rubbing with said rigid lighting surface; and
e) a sticker or slots for affixing said matches to the inner surface of said enclosure's cover, near said lighting surface.

2. A system according to claim 1, wherein the enclosure and/or the cover are made of metal, and having a shape of a can.

3. A system according to claim 1, in which the package is sealed.

4. A system according to claim 1, wherein the enclosure and/or the cover are made of a polymeric material such as plastic, and having a shape of a can.

5. A system according to claim 1, wherein the opening mechanism of the candle's enclosure is similar to the opening mechanism of a can/tin can.

6. A system according to claim 1, wherein the cover is sunken, for enabling putting candles in a stack one on top of each other, for storing and transporting packaged candles while saving space.

7. A system according to claim 1, wherein the rigid lighting surface is a phosphorus surface, similar to a matchbox.

8. A system according to claim 1, wherein the matches are affixed by a sticker to the inner side of the cover surface, near the phosphorus surface.

9. A system according to claim 1, wherein the matches lie scattered on the candle, in the space between the candle in the enclosure and the cover.

10. A system according to claim 1, wherein instead of using a sticker, the matches are inserted into slots, formed in the enclosure cover.

11. A system according to claim 1, wherein the enclosure's cover is used as a windshield when being in about 90° open position, for preventing the wind from extinguishing the candle flame and facilitates lighting the candle.
